(19) United States
(12) Patent Application Publication
(10) Pub. No.: US 2013/0193002 A1
(43) Pub. Date: Aug. 1, 2013

(54) APPARATUS FOR PRODUCING ELECTROLYTIC REDUCED WATER AND CONTROL METHOD THEREOF

(71) Applicant: Samsung Electronics Co., Ltd., Suwon (KR)

(72) Inventors: Jee Yeon KIM, Yongin (KR); Daeun KIM, Seoul (KR); Young Chul KO, Suwon (KR); Hyun Suk KWAK, Gwangju (KR)

(73) Assignee: SAMSUNG ELECTRONICS CO., LTD., Suwon (KR)

(21) Appl. No.: 13/747,782

(22) Filed: Jan. 23, 2013

(30) Foreign Application Priority Data
Jan. 26, 2012 (KR) 10-2012-0007593

(51) Int. Cl. C02F 1/461; C02F 1/467

(52) U.S. Cl. CPC C02F 1/4618; C02F 1/4676
USPC 205/747; 204/240

(57) ABSTRACT

An apparatus for producing electrolytic reduced water capable of improving the sterilization performance and a control method thereof, the apparatus including an electrolytic cell configured to produce electrolytic reduced water by electrolyzing purified water that is penetrated through a reverse osmosis filter of a water purifying unit, a water storage tank configured to store the electrolytic reduced water, a sterilization electrolytic cell configured to produce sterilization water by electrolyzing reverse osmosis waste water that is discharged from the water purifying unit, and a control unit configured to perform a control operation to sterilize at least one of the water storage tank, a cork connected to the water storage tank, and a pipe that connect the water storage tank to the electrolytic cell by use of the sterilization water.

### CROSS-REFERENCE TO RELATED APPLICATIONS

This application claims the benefit of Korean Patent Application No. 10-2012-0007593, filed on Jan. 26, 2012 in the Korean Intellectual Property Office, the disclosure of which is incorporated herein by reference.

### BACKGROUND

1. Field

Embodiments of the present disclosure relate to an apparatus for producing electrolytic reduced water and a control method thereof, and more particularly, to an apparatus for producing electrolytic reduced water capable of enhancing sterilization performance and a control method thereof.

2. Description of the Related Art

A water purifier includes at least one filter including a Reverse Osmosis (RO) filter. A water purifier produces neutral water in the range of pH 5.8 and pH 8.5 having turbidity, bacteria, viruses, organic compounds, agricultural pesticides, heavy metals, residual materials from sterilization, and inorganic iron eliminated by more than 70% to 90% therefrom.

However, the water produced from a water purifier is only configured to perform a basic function to help metabolism and relieve thirst of a human body to support life, and is not provided with a function to contribute in promoting health which may be represented as an Oxidation Reduction Potential (ORP).

In order to supplement the demerits and add the functionality of the water purifier as such, an alkali-ion water producing apparatus is developed. An alkali-ion water producing apparatus is a medical-purpose apparatus configured to produce water having the pH level greater than pH 8.5. The ionized water produced from the alkali-ion water producing apparatus is recognized by the Korea Food and Drug Administration as an apparatus having the effects in relieving symptoms of chronic diarrhea, and indigestion, as well as in relieving symptoms of a stomach such as heterofermentation and gastric hyperacidity. In addition, even in the medical field, the alkali-ion water producing apparatus, through clinical trials, is recognized to be effective in helping with diseases in internal organs and blood vessels, as well as in diabetes and atopic dermatitis. The cause of the effects as such is considered to be by a small amount of hydrogen gas that is present in water.

The alkali-ion water producing apparatus as such generates sterilization water by electrolyzing tap water, and sterilizes pipes and a storage tank by using sterilization water. However, in a case of using the sterilization water generated by electrolyzing tap water, high performance of sterilization is not likely to be anticipated.

### SUMMARY

Therefore, it is an aspect of the present disclosure to provide an apparatus for producing electrolytic reduced water capable of enhancing the sterilization performance and a control method thereof.

Additional aspects will be set forth in part in the description which follows and, in part, will be obvious from the description, or may be learned by practice of the disclosure.

In accordance with one embodiment, an apparatus for producing electrolytic reduced water includes an electrolytic cell, a water storage tank, a sterilization electrolytic cell and a control unit. The electrolytic cell may be configured to produce electrolytic reduced water by electrolyzing purified water that is penetrated through a reverse osmosis filter of a water purifying unit. The water storage tank may be configured to store the electrolytic reduced water. The sterilization electrolytic cell may be configured to produce sterilization water by electrolyzing reverse osmosis waste water that is discharged from the water purifying unit. The control unit may be configured to perform a control operation to sterilize at least one of the water storage tank, a cork connected to the water storage tank, and a pipe that connect the water storage tank to the electrolytic cell by use of the sterilization water.

The sterilization water may include hypochlorous acid.

The reverse osmosis waste water may be ion-concentrated liquid that fails to penetrate through the reverse osmosis filter.

The control unit, in a case of sterilizing according to an automatic sterilization mode, may sterilize the water storage tank and the pipe by using the sterilization water.

The control unit, after discharging the sterilization water that has been used in sterilizing the water storage tank and the pipe, may perform a cleaning of the sterilized water storage tank and the sterilized pipe by using the purified water that is penetrated through the reverse osmosis filter.

The control unit, in a case of sterilizing according to a manual sterilization mode, may sterilize the cork, the water storage tank, and the pipe by using the sterilization water.

The apparatus may further include a display unit configured to display information instructing to connect the cork to the sterilization electrolytic cell by using a hose.

The sterilization water, while being supplied from the sterilization electrolytic cell to the cork through the hose, may sterilize the cork.

The control unit, after discharging the sterilization water that has been used in sterilizing the cork, the water storage tank, and the pipe to an outside the water storage tank, may performs a cleaning of the sterilized cork, the sterilized water storage tank, and the sterilized pipe by using the purified water that is penetrated through the reverse osmosis filter.

In accordance with another aspect, a method of controlling an apparatus for producing electrolytic reduced water is as follows. An electrolytic cell may produce electrolytic reduced water by electrolyzing purified water that is penetrated through a reverse osmosis filter of a water purifying unit. A water storage tank may store the electrolytic reduced water. A sterilization electrolytic cell may produce sterilization water by electrolyzing reverse osmosis waste water that is discharged from the water purifying unit. A control unit may perform a control operation such that the sterilization water sterilizes at least one of the water storage tank, a cork connected to the water storage tank, and a pipe that connect the water storage tank to the electrolytic cell by use of the sterilization water.

The sterilization water may include hypochlorous acid.

The reverse osmosis waste water may be ion-concentrated liquid that fails to penetrate through the reverse osmosis filter.

The performing of the control operation may include, in a case of sterilizing according to an automatic sterilization mode, sterilizing the water storage tank and the pipe by using the sterilization water.

The method may be achieved by further performing as follows. The sterilization water having been used in sterilizing the water storage tank and the pipe may be discharged to an outside the water storage tank. The sterilized water storage tank and the sterilized pipes may be cleaned, by using the purified water that is penetrated through the reverse osmosis filter.

The performing of the control operation may include, in a case of sterilizing according to a manual sterilization mode, sterilizing the cork, the water storage tank, and the pipe by using the sterilization water.

The method may be achieved by further performing as follows. Information instructing to connect the cork to the sterilization electrolytic cell by using a hose may be displayed.

The sterilization water, while being supplied from the sterilization electrolytic cell to the cork through the hose, may sterilize the cork.

The method is achieved by further performing the follows. The sterilization water having been used in sterilizing the cork, the water storage tank, and the pipe may be discharged to an outside the water storage tank. The sterilized cork, the sterilized water storage tank, and the sterilized pipe may be cleaned by using the purified water that is penetrated through the reverse osmosis filter.

In accordance with the apparatus for producing electrolytic reduced water and a control method thereof, the following effects may be anticipated.

By electrolyzing the reverse osmosis waste water that is not penetrated through the reverse osmosis filter, the sterilization water is generated, and by using the sterilization water, the pipes and the water storage tank are cleaned, thereby enhancing the sterilization performance when compared to the case when using the sterilization water that is generated by electrolyzing tap water.

Since the sterilization water is generated by electrolyzing the reverse osmosis waste water that is not penetrated through the reverse osmosis filter, water may be conversed.

Since the cork having frequent propagation of microorganisms may be sterilized through the manual sterilization mode, safer water may be available for consumption.

Through the automatic sterilization mode, the water storage tank at an inside the apparatus for producing electrolytic reduced water as well as the pipes connected to the water storage tank may be periodically sterilized, and a user may clean the water storage tank and the piped connected to the water storage tank without making contacts with the sterilization water.

### BRIEF DESCRIPTION OF THE DRAWINGS

These and/or other aspects will become apparent and more readily appreciated from the following description of the embodiments, taken in conjunction with the accompanying drawings of which:

FIG. 1 is a drawing schematically illustrating the structure of an apparatus for producing electrolytic reduced water in accordance with one embodiment.

FIG. 2 is a drawing schematically illustrating the structure of a sterilization electrolytic cell of an apparatus for producing electrolytic reduced water in accordance with one embodiment.

FIG. 3 is a block diagram schematically illustrating the control operation of an apparatus for producing electrolytic reduced water in accordance with one embodiment.

FIG. 4 is a flow chart schematically illustrating a method of controlling an apparatus for producing electrolytic reduced water in accordance with one embodiment.

FIG. 5 is a drawing illustrating an overall image of a sterilization electrolytic cell and a cork connected to each other by a hose at an apparatus for producing electrolytic reduced water in accordance with one embodiment.

### DETAILED DESCRIPTION

Reference will now be made in detail to the embodiments, examples of which are illustrated in the accompanying drawings, wherein like reference numerals refer to like elements throughout.

Hereinafter, by referring to the drawings, an apparatus for reduced water by electrolysis and the control method thereof will be described. On the drawings, the same marks represent the same elements of the structure.

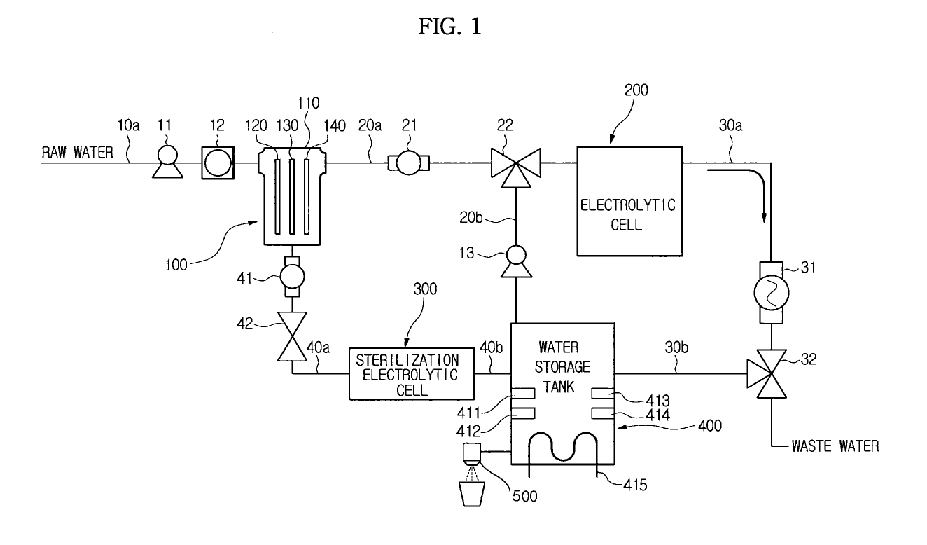

FIG. 1 is a drawing schematically illustrating the structure of an apparatus for producing electrolytic reduced water in accordance with one embodiment.

Referring to FIG. 1, an apparatus for producing reduced water may include a water purifying unit 100, an electrolytic cell 200, a sterilization electrolytic cell 300, and a water storage tank 400.

The water purifying unit 100 filters the turbidity of the incoming water, when the water (hereinafter called raw water) introduced from an outside is entered through a booster pump 11 and a decompression valve 12 provided on a pipe 10a. The water purifying unit 100 may include a chamber 110 and a plurality of filters 120, 130, and 140 provided at an inside the chamber 110.

The chamber 110 may include an inlet port (not shown) through which the raw water is introduced, a purified water discharging port (not shown), and a reverse osmosis waste water discharging port (not shown). The purified water discharging port is connected to the electrolytic cell 200 through a pipe 20a. The reverse osmosis waste water discharging port is connected to a reverse osmosis waste water inlet port of the sterilization electrolytic cell 300.

At an inside the chamber 110, the plurality of filters 120, 130, and 140 are provided, and as for the filters, for example, the sediment filter 120, the pre-carbon filter 130, and the reverse osmosis filter 140 may be provided.

The sediment filter 120 eliminates the dust, the residues, and the contaminated substances, which have a size greater than 0.5 micron, from the raw water. The pre-carbon filter 130 adsorbs and controls the hazardous chemical substances and the organic chemical substances that are dissolved in the raw water. The reverse osmosis filter 140 eliminates the free and residual chloride, chromaticity, turbidity, chloroform, microorganism, and bacteria, in the raw water. The reverse osmosis filter 140 also eliminates the organic compounds, the pesticides, the heavy metals, and inorganic substances in the raw water, to penetrate only the pure water.

The filters 120, 130, and 140 as such may be formed as a separate filter to each other, or may be formed in a single unit. In the descriptions hereinafter, the case when the water purifying unit 100 includes the reverse osmosis filter 140 will be used as an example for the descriptions. In addition, the pure water that is penetrated through the reverse osmosis filter 140 is referred to as ‘purified water’, and the ion-concentrated liquid that is not penetrated through the reverse osmosis filter 140 is referred to as ‘reverse osmosis waste water’.

The purified water that is penetrated through the reverse osmosis filter 140 is discharged to the purified water discharging port of the chamber 110, and is supplied to the electrolytic cell 200 through the pipe 20a that connects the water purifying unit 100 to the electrolytic cell 200. At this time, on the pipe 20a, a flow control valve 21 and a three-way valve 22 may be provided in the order of which they are mentioned above. One end of the three-way valve 22 may be connected to the water storage tank 400 by the pipe 20b, and on the pipe 20b, a pump may be provided to smoothly supply the purified water, which is discharged from the water purifying unit 100, to the water storage tank 400.

The reverse osmosis waste water that is not penetrated through the reverse osmosis filter 140 is discharged through the reverse osmosis waste water discharging port of the chamber 110, and through a pipe 40a that connects the water purifying unit 100 to the sterilization electrolytic cell 300, the reverse osmosis waste water is supplied to the sterilization electrolytic cell 300. At this time, on the pipe 40a, a flow control valve 41 and a valve 42 may be provided in the order of which they are mentioned above.

The electrolytic cell 200 electrolyzes the purified water, which is supplied from the water purifying unit 100 by applying constant electric energy, to generate the electrolytic reduced water. Here, the electrolytic reduced water is referred to as the water in which the hydrogen gas in a neutral state is present in the range of approximately pH 5.8 and pH 8.5, and is provided with an oxidation-reduction potential value of approximately −500 mV.

The electrolytic cell 200 as such, although not illustrated on the drawing, may include a chamber, a first electrode, a second electrode, and an ion-exchanging membrane that is positioned in between the first electrode and the second electrode.

At one side of the chamber, a purified water inlet port through which the purified water is introduced, and a discharging port through which the electrolytic reduced water generated at an inside the chamber is discharged, may be formed. The purified water inlet port of the chamber is connected to the purified water discharging port of the water purifying unit 100 through the pipe 20a. On the pipe 20a that connects the purified water discharging port of the water purifying unit 100 to the purified water inlet port of the chamber, the flow control valve 21 and the three-way valve 22 may be provided in the order of which they are mentioned above. The flow control valve 21 controls the amount of the purified water that is supplied to the electrolytic cell 200. The three-way valve 22 may be controlled to be open/closed so that the purified water, which is discharged from the purified water discharging port, is supplied to the electrolytic cell 200, or so that the purified water, which is discharged from the purified water discharging port of the water purifying unit 100, is supplied to the water storage tank 400.

The discharging port of the chamber of the electrolytic cell 200 is connected to the water storage tank 400 through pipes 30a and 30b. On the pipes 30a and 30b that connect the discharging port of the chamber of the electrolytic cell 200 to the water storage tank 400, a flow rate control valve 31 and a three-way valve 32 are provided in the order of which they are mentioned above. The flow rate control valve 31 controls the flow rate of the electrolytic reduced water that is discharged from the electrolytic cell 200. For example, the flow rate control valve 31 is configured to maintain the flow rate of the electrolytic reduced water, which is discharged from the electrolytic cell 200, at about 100 mL/min. The three-way valve 32 may be controlled to be open/closed so that the electrolytic reduced water, which is discharged from the electrolytic cell 200, is supplied to the water storage tank 400, or so that the electrolytic reduced water, which is stored in the water storage tank 400, is discharged to an outside.

The first electrode and the second electrode of the electrolytic cell 200 are symmetrically positioned in a bilateral manner at an inside the chamber. Here, the first electrode may be a positive electrode, and the second electrode may be a negative electrode. At the first electrode and at the second electrode, the electricity having a different polarity is applied, and as a result, the purified water at an inside the chamber is electrolyzed. At this time, the polarity of the electricity that is applied to the first electrode and the second electrode may be alternatively changed.

The water storage tank 400 is connected to the discharging port of the electrolytic cell 200 through the pipes 30a and 30b, and stores the electrolytic reduced water generated at the electrolytic cell 200. The water storage tank 400 may be provided therein with a water level detecting unit 411 to detect the level of the electrolytic reduced water that is stored at the water storage tank 400, a temperature detecting unit 412 to detect the temperature of the electrolytic reduced water, a pH detecting unit 413 to detect the concentration level of the hydrogen ion (pH) of the electrolytic reduced water, and an ORP detecting unit 414 to detect the Oxidation Reduction Potential (ORP) of the electrolytic reduced water. At this time, the pH detecting unit 413 and the ORP detecting unit 414 may be separately formed from each other, and also be integrally formed.

In addition, at an inside the water storage tank 400, a refrigerant pipe 415 may be provided. The refrigerant pipe 415 is a pipe through which a refrigerant flows. In a case when the temperature of the electrolytic reduced water stored at the water storage tank 400 is higher than the reference temperature (for example, 4° C.), a refrigerant is supplied to the refrigerant pipe 415. The refrigerant supplied to the refrigerant pipe, while flowing through the refrigerant pipe 415, takes away the heat of the electrolytic reduced water, so that the temperature of the electrolytic reduced water is decreased.

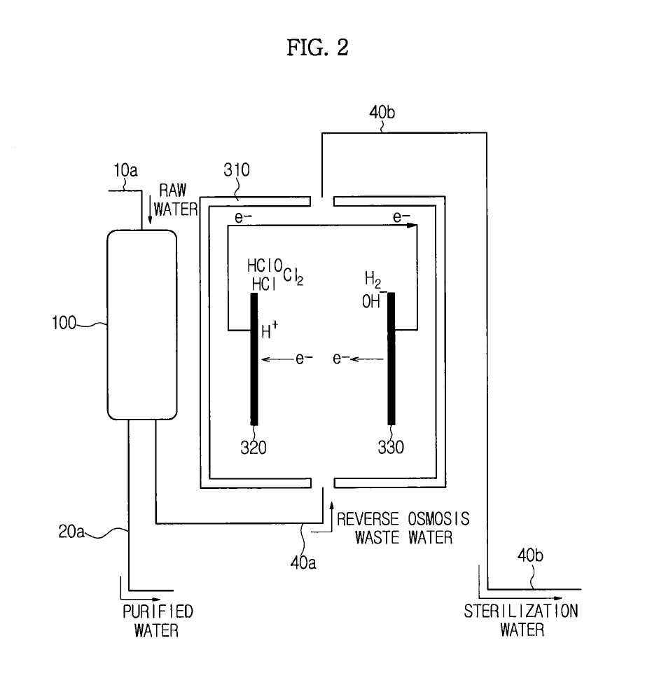

In addition, at one side of the water storage tank 400, a cork 500 may be provided. The cork 500 may be open/closed by the manipulation of a user, and supplies the electrolytic reduced water to a user by discharging the electrolytic reduced water at an inside the water storage tank 400. Since the electrolytic reduced water stored at the water storage tank 400 as such is ultimately supplied to a user through the cork 500, even if the water storage tank 400 or the pipes 30a and 30b connecting the water storage tank 400 to the discharging port of the electrolytic cell 200 are cleaned, the water may be contaminated by the bacteria that remains at the cork 500 in the process of the electrolytic reduced water is being discharged through the cork 500. By performing an automatic sterilization mode, the water storage tank 400 and the pipes 30a and 30b connecting the water storage tank 400 to the discharging port of the electrolytic cell 200 are sterilized. By performing a manual sterilization mode, the water storage tank 400, the pipes 30a and 30b connecting the water storage tank 400 to the discharging port of the electrolytic cell 200, and the cork 500 may be sterilized. More detailed descriptions of such will be provided below by referring to FIGS. 2 to 4.

The sterilization electrolytic cell 300 is positioned in between the water purifying unit 100 and the water storage tank 400. The sterilization electrolytic cell 300, by electrolyzing the reverse osmosis waste water supplied at the water purifying unit 100, generates the sterilization water. The sterilization water that is generated is supplied to the water storage tank 400, and is used to sterilize at least one of the water storage tank 400, the pipes 30a and 30b connecting the water storage tank 400 to the discharging port of the electrolytic cell 200, and the cork 500. Here, by referring to FIG. 2, the operation principle of the sterilization electrolytic cell 300 will be described more in detail.

FIG. 2 is a drawing schematically illustrating the structure of a sterilization electrolytic cell of an apparatus for producing electrolytic reduced water in accordance with one embodiment.

As illustrated on FIG. 2, the sterilization electrolytic cell 300 may include a chamber 310, a first electrode 320, and a second electrode 330.

At one side of the chamber 310, the reverse osmosis waste water inlet port, through which the reverse osmosis waste water that is discharged from the water purifying unit 100, is formed. The reverse osmosis waste water inlet port is connected to the reverse osmosis waste water discharging port of the water purifying unit 100 through a pipe 40a. On the pipe 40a connecting the reverse osmosis waste water inlet port on the sterilization the electrolytic cell 300 to the reverse osmosis waste water discharging port of the water purifying unit 100, a flow control valve 41 and a valve 42 are provided in the order of which they are mentioned above. At the other end of the chamber 310, a plurality of sterilization water discharging ports is formed to discharge the sterilization water generated at an inside the chamber 310. One of the plurality of sterilization water discharging ports is connected to the water storage tank 400 by the pipe 40b, and the remaining one of the plurality of sterilization water discharging ports may be connected to the cork 500 by a hose.

At an inside the chamber 310 of the sterilization electrolytic cell 300, the first electrode 320 having a positive polarity and the second electrode 330 having a negative polarity are symmetrically installed in a bilateral manner. The titanium Ti having coasted with platinum Pt may be used as the first electrode 320 and the second electrode 330. As one example, the first electrode 320 and the second electrode 330 may be provided the form of mesh type to increase the surface area. As another example, the first electrode 320 and the second electrode 330 may be provided with holes formed thereto in a certain interval so that water may pass through.

When a voltage is applied to the first electrode 320 and the second electrode 330 of the sterilization electrolytic cell 300, the reverse osmosis waste water introduced to an inside the chamber 310 is electrolyzed. At this time, the reaction formula of what take place at the first electrode 320 and the second electrode 330 may be expressed as the Reaction Formula 1 below:

(+ Polarity): 2Cl⁻→Cl₂+2e⁻

Cl₂+H₂O→HCl+HOCl

H₂O→1/2O₂+2H⁺+2e⁻

(− Polarity): 2H₂O+2e⁻→H₂+2OH⁻

H⁺+OH⁻→H₂O [Reaction Formula 1]

As seen from the Reaction Formula 1, chlorine Cl (Cl₂), hydrogen chloride (HCl), hypochlorous acid (HOCl), oxygen (O₂), hydrogen ion (H+), and electron (e−) are generated at the first electrode 320 having a positive polarity. Among the above, the hypochlorous acid is one of the oxygen acids, and is also referred to as a hypochlorous acid is provided with sterilization ability. The sterilization water having hypochlorous acid is discharged through the sterilization water discharging port of the chamber 310.

Meanwhile, the distance between the first electrode 320 and the second electrode 330, for example, may be about 1 mm. However, the distance between the first electrode 320 and the second electrode 330 is not limited to about 1 mm, and may be determined experimentally according to the condition of the raw water. The Table 1 below illustrates the sterilization abilities of the sterilization water after generating the sterilization water by having different distances in between the first electrode 320 and the second electrode 330.

TABLE 1
(Initial Concentration = 1.3 × 10⁵ CFU/mL)

| Electrode | Current | Voltage | Power | Temp. | ORP | | Cl | Germs (CFU/mL) | | | |
|---|---|---|---|---|---|---|---|---|---|---|---|
| gap (mm) | (A) | (V) | (W) | (° C.) | (mV) | pH | (ppm) | 30 sec | 3 min | 5 min | Remarks |
| 0.5 | 1 | 5.7 | 5.7 | 26 | 50 | 7.42 | 0.07 | — | — | — | |
| | 2 | 8.3 | 16.6 | 26.4 | 30 | 7.3 | 0.18 | 160 | 60 | 0 | Sterilization effect |
| | | | | | | | | | | | 99.7%→99.99% |
| 1 | 1 | 8 | 8 | 25.7 | −190 | 7.27 | 0.14 | 540 | 160 | 20 | Sterilization effect |
| | | | | | | | | | | | 99.5%→99.98% |
| | 2 | 12.5 | 25 | 26.8 | −180 | 7.5 | 0.38 | 0 | 0 | 0 | |
| | 3 | 17 | 51 | 28.2 | −173 | 7.66 | 0.49 | 0 | 0 | 0 | |

* Test Culture: E. coli (used after centrifugally separated)
* Concentration Level of Test Culture at Initial Stage: 1.3 × 10⁵ CFU/mL
* Flow Speed of Sterilization Water: 250 mL/min

Referring to the Table 1, in a case when the distance between the first electrode 320 and the second electrode 330 is about 0.5 mm, germs (bacteria) are present, while in a case when the distance between the first electrode 320 and the second electrode 330 is about 1 mm, bacteria is not present. By referring to the Table 1, under the condition of the test above, when the rate of chlorine being generated and the sterilization ability are considered, the distance between the first electrode 320 and the second electrode 330 is desired to be about 1 mm, and the current applied to the first electrode 320 and the second electrode 330 is desired to be about 2 A or 3 A. Here, the current applied to the first electrode 320 and the second electrode 330 is not limited to 2 A or 3 A, but may be determined experimentally according to the condition of the raw water. The Table 2 below illustrates the sterilization abilities of the sterilization water after differentiating the current applied to the first electrode 320 and the second electrode 330.

TABLE 2
(Initial Concentration = 1.3 × 10⁵ CFU/mL)

| Electrode | Current | Voltage | Power | Temp. | ORP | | Cl | Germs (CFU/mL) | | | |
|---|---|---|---|---|---|---|---|---|---|---|---|
| gap (mm) | (A) | (V) | (W) | (° C.) | (mV) | pH | (ppm) | 30 sec | 3 min | 5 min | Remarks |
| 1 | 2 | 12.5 | 25 | 26.8 | −180 | 7.5 | 0.38 | 0 | 0 | 0 | |
| | | 12.5 | 25 | 24.8 | −216 | 7.3 | 0.22 | 140 | 40 | 0 | Sterilization effect |
| | | | | | | | | | | | 99.8%→99.99% |
| | | 12 | 24 | 26.2 | −225 | 7.2 | 0.24 | 40 | 0 | 0 | Sterilization effect |
| | | | | | | | | | | | 99.97%→99.99% |
| | | 12 | 24 | 26.3 | −209 | 7.3 | 0.29 | 0 | 0 | 0 | |
| | 3 | 17 | 51 | 28.2 | −173 | 7.66 | 0.49 | 0 | 0 | 0 | |
| | | 16 | 48 | 27.6 | −156 | 7.3 | 0.53 | 0 | 0 | 0 | |
| | | 16 | 48 | 27.7 | −190 | 7.4 | 0.54 | 0 | 0 | 0 | |

By referring to the Table 2, in a case when the first electrode 320 and the second electrode 330 is applied with the current of about 2 A, bacteria is present, while in a case when the first electrode 320 and the second electrode 330 is applied with the current of about 3 A, bacteria is not present. Thus, under the condition of the test above, the current applied to the first electrode 320 and the second electrode 330 is desired to be about 3 A.

The sterilization water discharged through the sterilization water discharging port of the chamber 310 is used to sterilize at least one of the water storage tank 400, the pipes 30a and 30b connecting the water storage tank 400 to the discharging port of the electrolytic cell 200, and the cork 500 connected to the water storage tank 400. The determination on which one, that is, among the water storage tank 400, the pipes 30a and 30b connecting the water storage tank 400 and the discharging port of the electrolytic cell 200, and the cork 500 connected to the water storage tank 400, is to be sterilized, depends on the sterilization mode. In detail, the apparatus for producing electrolyzed reduced water provides an automatic sterilization mode and a manual sterilization mode, and in a case when sterilizing according to the automatic sterilization mode, the sterilization is performed on the water storage tank 400, and the pipes 30a and 30b connecting the water storage tank 400 to the discharging port of the electrolytic cell 200. If, in a case when sterilizing according to the manual sterilization mode, the sterilization is performed on the water storage tank 400, the pipes 30a and 30b connecting the water storage tank 400 to the discharging port of the electrolytic cell 200, and the cork 500 connected to the water storage tank 400.

The automatic sterilization mode may be periodically performed without a user separately configuring the function as such. For example, the automatic sterilization mode may be performed once in every three days. At this time, the period of the automatic sterilization mode being performed is not limited to three days, but by considering the propagation of the bacteria at the electrolytic reduced water stored at the water storage tank 400, the automatic sterilization mode may be performed in a shorter period of interval. The sterilization process according to the automatic sterilization mode includes a stage to discharge the electrolytic reduced water stored at the water storage tank 400 to an outside, a stage to generate the sterilization water by using the reverse osmosis waste water discharged from the water purifying unit 100, a stage to sterilize the water storage tank 400 and the pipes 30a and 30b connecting the water storage tank 400 to the discharging port of the electrolytic cell 200 by using the sterilization water generated, a stage to discharge the sterilization water having been used in the sterilization to an outside, and a stage to clean the water storage tank 400, and the pipes 30a and 30b connecting the water storage tank 400 to the discharging port of the electrolytic cell 200, by use of the purified discharged from the water purifying unit 100.

The manual sterilization mode is referred to the sterilization mode that is performed when the selection by a user to perform such is present, and the user may intervene in the process of performing sterilization. The sterilization mode according to the manual sterilization mode includes a stage when a user selects the manual sterilization mode, a stage when a user connects the sterilization electrolytic cell 300 to the cork 500 using a hose, a stage when the electrolytic reduced water stored at the water storage tank 400 is discharged to an outside, a stage when the sterilization water is being generated by using the reverse osmosis waste water discharged from the water purifying unit 100, a stage to sterilize the water storage tank 400, the pipes 30a and 30b connecting the water storage tank 400 to the discharging port of the electrolytic cell 200, and the cork 500 by using the sterilization water generated, a stage to discharge the sterilization water having been used for the sterilization, and a stage to clean the water storage tank 400, the pipes 30a and 30b connecting the water storage tank 400 to the discharging port of the electrolytic cell 200, and the cork 500 by using the purified water discharged from the water purifying unit 100. The hose connecting the sterilization electrolytic cell 300 to the cork 500, for example, may be provided at the water storage tank 400, or may be provided at a space separately prepared at the apparatus for reduced water by electrolysis. A user, after selecting the manual sterilization mode, may connect one end of the hose to the cork 500, and connect the other end of the hose to the sterilization electrolytic cell 300.

Meanwhile, in the example described previously, the case when a user connects the sterilization electrolytic cell 300 to the cork 500 using the hose after the user selects the manual sterilization mode is described. However, it is not necessarily needed to follow the process as such, as the user, by using the hose, may connect the sterilization electrolytic cell 300 and the cork 500, and then select the manual sterilization mode. The frequency of cleaning at least one of the water storage tank 400, the pipes 30a and 30b connecting the water storage tank 400 to the discharging port of the electrolytic cell 200, and the cork 500 is at least twice, and may be determined experimentally.

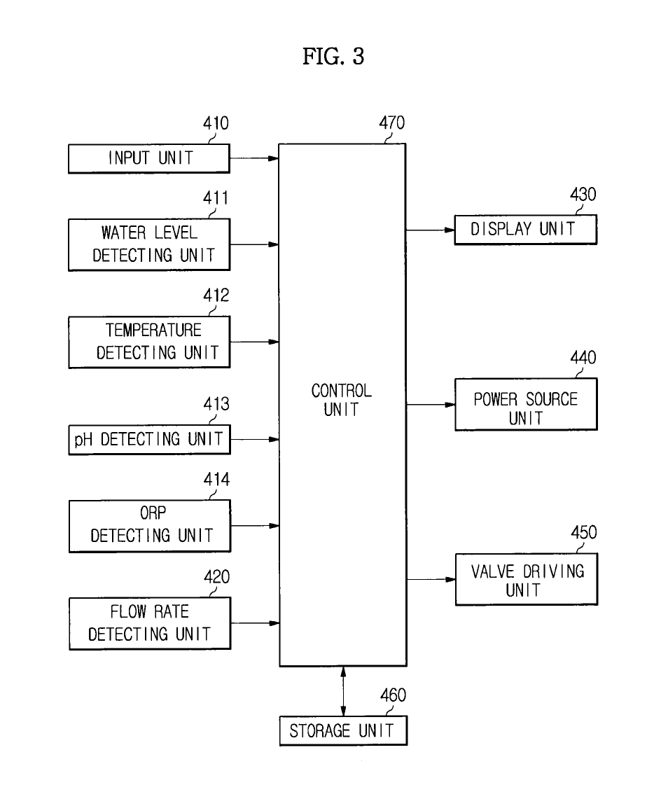

FIG. 3 is a block diagram schematically illustrating the control operation of an apparatus for producing electrolytic reduced water in accordance with one embodiment.

As illustrated on FIG. 3, the apparatus for reduced water by electrolysis may include an input unit 410, the water level detecting unit 411, the temperature detecting unit 412, the pH detecting unit 413, the ORP detecting unit 414, a flow rate detecting unit 420, a control unit 470, a storage unit 460, a display unit 430, a power supply unit 440, and a valve driving unit 450.

The input unit 410 receives a command from a user. For example, the input unit 410 may receive the command to select the sterilization mode from a user. For such, the input unit 410 may include a plurality of keys and buttons.

The display unit 430 may display the process result of the command that is entered by a user. For example, in a case when a user selected the manual sterilization mode through the input unit 410, the guide information, which instructs to connect the sterilization water discharging port of the sterilization electrolytic cell 300 to the cork 500 using a hose, may be displayed. The user, after confirming the guide information displayed on the display unit 430, by using the hose provided at the water storage tank 400, may connect the sterilization water discharging port of the sterilization electrolytic cell 300 to the cork 500. The display unit 430 as such may be formed with s display apparatus such as a LCD. The input unit 410 and the display unit 430 described previously may be separately provided in the form of a hardware, or may be provided in an integrated form in the form of a touch screen.

The water level detecting unit 411 detects the water level of the electrolytic reduced water stored at the water storage tank 400, and provides the water level data detected to the control unit 470.

The temperature detecting unit 412 detects the temperature of the electrolytic reduced water stored at the water storage tank 400, and provides the temperature data detected to the control unit 470.

The pH detecting unit 413 detects the concentration level of the hydrogen ion, that is, pH, of the electrolytic reduced water stored at the water storage tank 400, and provides the pH data detected to the control unit 470.

The ORP detecting unit 414 detects the ORP of electrolytic reduced water that is stored in the water storage tank 400, and provides the detected ORP data to the control unit 470.

The flow rate detecting unit 420 detects the flow rate of the purified water discharged from the water purifying unit 100, the flow rate of the reverse osmosis waste water discharged from the water purifying unit 100, and the flow rate of the electrolytic reduced water discharged from the electrolytic cell 200. The flow rate data detected is provided to the control unit 470. The flow rate detecting unit 420 may be provided at the front end of the rear end of flow control valves 21, 31, and 41 installed at the pipes 20a, 40, and 40a, respectively, or may be provided in an integrated form with the flow control valves 21, 31, and 41.

The control unit 470 is electrically connected to the input unit 410 and to each of the detecting units 411, 412, 413, 414, and 420, and receives data from the input unit 410 and to each of the detecting units 411, 412, 413, 414, and 420. Based on the data provided, the control unit 470 may control at least one of the display unit 430, the power supply unit 440, and the valve driving unit 450.

In detail, in a case when the electrolytic reduced water is generated, the control unit 470 controls the power supply unit 440 to control the voltage that is supplied to the two polarities of the electrolytic cell 200. In addition, the control unit 470 controls the valve driving unit 450 to supply the purified water at a constant speed to the electrolytic cell 200.

In addition, in a case when the sterilization mode is performed, the control unit 470 distinguishes whether the sterilization mode, which is to be performed, is the automatic sterilization mode or the manual sterilization mode, and according to the result of the distinction made, the control unit 470 enables the guide information to be displayed on the display unit 430. By controlling the power supply unit 440, the voltage, which is supplied to the two electrodes 320 and 330 of the sterilization electrolytic cell 300, may be controlled. In addition, the control unit 470, by controlling the valve driving unit, enables the reverse osmosis waste water, which is discharged from the water purifying unit 100, to be supplied to the sterilization electrolytic cell 300, and also enables the sterilization water, which is generated at the sterilization electrolytic cell 300, to be supplied to the pipes 30a and 30b that connect the water storage tank 400 to the discharging port of the electrolytic cell 200. For the control as such, the control unit 470 may refer to the data stored at the storage unit 460.

The storage unit 460, in a case when the sterilization mode is being performed, may store the data needed for the control unit 470 to control the display unit 430, the power supply unit 440, and the valve driving unit 450. For example, the storage unit 460 may store the magnitudes of the voltage and the current applied to the two electrodes 320 and 330 of the sterilization electrolytic cell 300, the number of the cleaning operations using the purified water, and the flow speed of the sterilization water being supplied to the water storage tank 400. In addition, the storage unit 460, in a case when generating the electrolytic reduced water, may store the data needed for the control unit 470 to control the power supply unit 440 and the valve driving unit 450.

The storage unit 460 as such may include a non-volatile memory terminal, such as a Read Only Memory (ROM), a Random Access Memory (RAM), a Programmable Read Only Memory (PROM), an Erasable Programmable Read Only Memory (PROM) and a flash memory; a volatile memory terminal such as a Random Access Memory (RAM); a hard disk; or an optical disk. However, the storage unit 450 is not limited to the examples described above, and may be provided in a different random form that is known in the industry.

The power supply unit 440 applies a constant current to the two electrodes 320 and 330 that are provided at the sterilization electrolytic cell 300 and also to the two electrodes that are provided at the electrolytic cell 200.

The valve driving unit 450, according to the control signal of the control unit 470, controls the opening/closing of the flow control valves 21, 31, and 41, and the opening/closing of the three-way valves 22, 32, and 42.

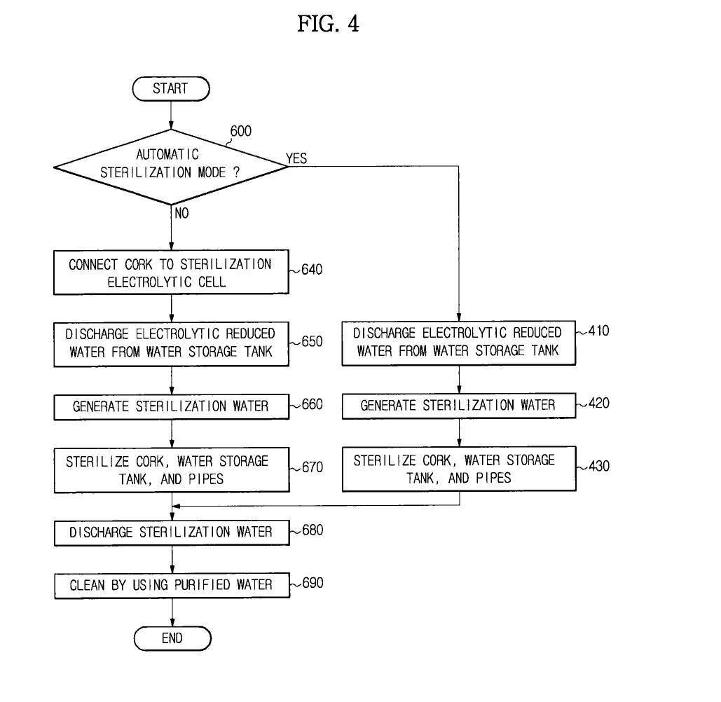

FIG. 4 is a flow chart schematically illustrating a method of controlling an apparatus for producing electrolytic reduced water in accordance with one embodiment.

As the sterilization mode starts, the control unit 470 determines whether the sterilization mode, which is to be performed, is the auto sterilization mode (600).

With the result of the determination from the stage 600, if the sterilization mode to be performed is the automatic sterilization mode (‘YES’ from 600), the control unit 470 controls the components, so that the electrolytic reduced water that is stored at the water storage tank 400 may be discharged to an outside (610). In detail, the control unit 470 controls the opening/closing of the three-way valve 32 installed on the pipes 30a and 30b that connect the water storage tank 400 to the discharging port of the electrolytic cell 200, so that the electrolytic reduced water stored at the water storage tank 400 may be discharged to an outside.

After the above, the control unit 470, in order for the sterilization water to be generated from the sterilization electrolytic cell 300, controls the components (620). In detail, the control unit 470 controls the opening/closing of the three-way valve 42 installed on the pipe 40a that connects the water purifying unit 100 to the sterilization electrolytic cell 300, so that the reverse osmosis waste water that is not penetrated through the reverse osmosis filter of the water purifying unit 100 may be supplied to the sterilization electrolytic cell 300. Also, by having the predetermined current applied to the first electrode 320 and the second electrode 330 of the sterilization electrolytic cell 300, the reverse osmosis waste water may be electrolyzed at an inside the chamber 310. When the reverse osmosis waste water is electrolyzed, the sterilization water having hypochlorous acid (HOCl) is generated.

After the above, the control unit 470, by using the sterilization water generated, controls the components so that the water storage tank 400, and the pipe 30b connecting the water storage tank 400 to the discharging port of the electrolytic cell 200 are sterilized (630). In detail, when the sterilization water generated at the sterilization electrolytic cell 300 is supplied to the water storage tank 400, the control unit 470 opens the three-way valve 32 on the pipes 30a and 30b that connect the water storage tank 400 to the discharging port of the electrolytic cell 200, so that the sterilization water may be supplied to the corresponding pipes 30a and 30b. At this time, the control unit 470, in order for the sterilization water, which is supplied to the pipes 30a and 30b, not to be introduced to an inside the chamber of the electrolytic cell 200, may control the components.

When the sterilization is completed, the control unit 470 controls the components, so that waste water, that is, the sterilization water, which has been used for the sterilization of the water storage tank 400 and the pipes 30a and 30b, is discharged to an outside (680). In detail, the control unit 470 controls the opening/closing of the three-way valve 32 on the pipes 30a and 30b that connect the water storage tank 400 to the discharging port of the electrolytic cell 200, so that the sterilization water that has been used for the sterilization may be discharged to an outside.

When the discharging of the waste water is completed, the control unit 470 controls the components, so that the sterilized water storage tank 400 and the sterilized pipes 30a and 30b may be cleaned by using the purified water that is discharged from the water purifying unit 100 (690). In detail, the control unit 470, by controlling the opening/closing of the three-way valve 22 installed in between the purified water discharging port of the water purifying unit 100 and the water storage tank 400, enables the purified water discharged from the water purifying unit 100 to be introduced to an inside the water storage tank 400 through the three-way valve 22, the pipe 20b, and a pump 13. After the above, the control unit 470, by controlling the opening/closing of the three-way valve 32 installed on the pipes 30a and 30b that connect the water storage tank 400 to the discharging port of the electrolytic cell 200, enables the purified water at an inside the water storage tank 400 to be introduced to the corresponding pipes 30a and 30b. As a result of the above, the water storage tank 400 and the pipes 30a and 30b that connect the water storage tank 400 to the discharging port of the electrolytic cell 200 are cleaned.

When the cleaning of the water storage tank 400 and the pipes 30a and 30b that connect the water storage tank 400 to the discharging port of the electrolytic cell 200 is completed, the control unit 470 controls the opening/closing of the three-way valve 32 installed on the pipes 30a and 30b that connect the water storage tank 400 to the discharging port of the electrolytic cell 200, so that the waster water, that is, sterilization water having been used for the sterilization, may be discharged to an outside.

The cleaning process using the purified water may be performed by a predetermined number of operation times. As an example, in a case when the operation times of the cleaning is set to be performed twice, the control unit 470, in order for the cleaning process using the purified water to be performed one more time, may control the components.

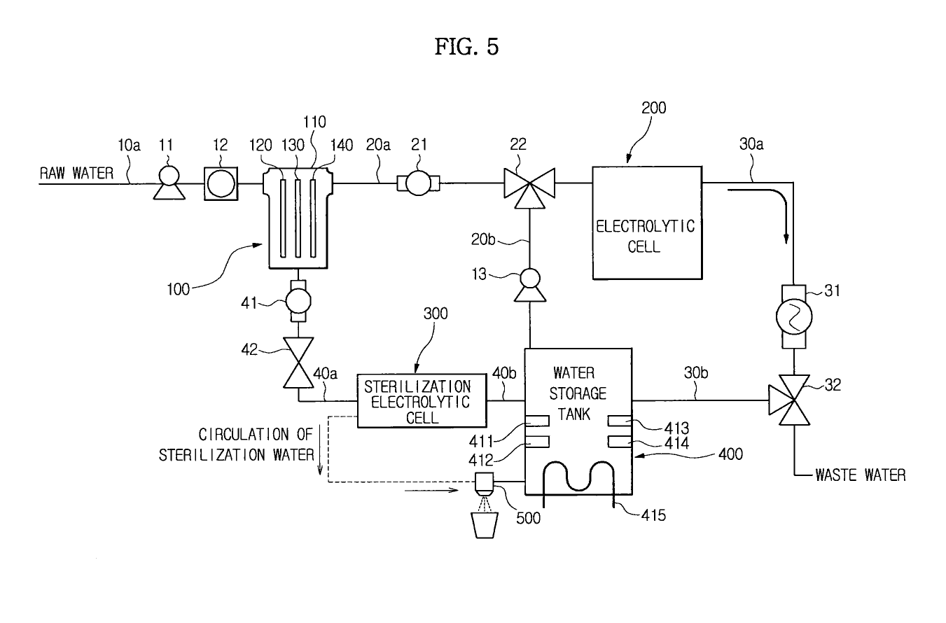

With the result of the determination from the stage 600, if the sterilization mode to be performed is the manual sterilization mode (‘NO’ from 600), the control unit 470 displays the guide information, which instructs to connect the cork 500 to the sterilization water discharging port of the sterilization electrolytic cell 300, through the display unit 430. The user, after confirming the guide information displayed on the display unit 430, by taking out the hose provided at the water storage tank 400, as illustrated on FIG. 5, connects the sterilization water discharging port of the sterilization electrolytic cell 300 to the cork 500 by using the hose 510 (640).

When the sterilization water discharging port of the sterilization electrolytic cell 300 is connected to the cork 500 with the hose 510, the control unit 470, in order for the electrolytic reduced water stored at the water storage tank 400 to be discharged to an outside, controls the components (650). In detail, the control unit 470 controls the opening/closing of the three-way valve 32 installed on the pipes 30a and 30b that connect the water storage tank 400 to the discharging port of the electrolytic cell 200, so that the electrolytic reduced water stored at the water storage tank 400 may be discharged to an outside.

After the above, the control unit 470, in order for the sterilization water to be generated from the sterilization electrolytic cell 300, controls the components (660). In detail, the control unit 470 controls the opening/closing of the valve 42 installed on the pipe 40a that connects the water purifying unit 100 to the sterilization electrolytic cell 300, so that the reverse osmosis waste water that is discharged from the water purifying unit 100 may be supplied to the sterilization electrolytic cell 300. Also, by having the predetermined current applied to the first electrode 320 and the second electrode 330 of the sterilization electrolytic cell 300, the reverse osmosis waste water may be electrolyzed at an inside the chamber 310. When the reverse osmosis waste water is electrolyzed, the sterilization water having hypochlorous acid (HOCl) is generated.

After the above, the control unit 470, by using the sterilization water generated, controls the components so that the water storage tank 400, the cork 500 connected to the water storage tank 400, and the pipes 30a and 30b connecting the water storage tank 400 to the discharging port of the electrolytic cell 200 are sterilized by use of the generated sterilization water (670). In detail, the control unit 470 opens the cork 500, so that the sterilization water generated at the sterilization electrolytic cell 300 may be supplied to the water storage tank 400 by passing through the cork 500. In addition, the control unit 470 opens the three-way valve 32 on the pipes 30a and 30b that connect the water storage tank 400 to the discharging port of the electrolytic cell 200. As a result of the above, the sterilization water, which is supplied from the sterilization electrolytic cell 300 to the water storage tank 400, and the sterilization water, which is introduced through the cork 500 to the water storage tank 400 by passing through the cork 500, may be supplied to the corresponding pipes 30a and 30b. At this time, the control unit 470, in order for the sterilization water, which is supplied to the pipes 30a and 30b, not to be introduced to an inside the electrolytic cell 200, may control the components.

When the sterilization is completed, the control unit 470 controls the components, so that waste water, that is, the sterilization water which has been used for the sterilization of the cork 500, the water storage tank 400 and the pipes 30a and 30b, is discharged to an outside (680). In detail, the control unit 470 controls the opening/closing of the three-way valve 32 on the pipes 30a and 30b that connect the water storage tank 400 to the discharging port of the electrolytic cell 200, so that the sterilization water that has been used for the sterilization may be discharged to an outside. When the discharging of the waste water is completed, the hose 510 connecting the sterilization electrolytic cell 300 to the water storage tank 400 may be removed by a user. For the above, the control unit 470 may display the guide information to remove the hose 510 through the display unit 430.

When the hose 510 is removed, the control unit 470 controls the components, so that the sterilized cork 500, the sterilized water storage tank 400 and the sterilized pipes 30a and 30b may be cleaned by using the purified water discharged from the water purifying unit 100 (690). In detail, the control unit 470, by controlling the opening/closing of the three-way valve 22 installed on the pipes 20a and 20b connecting the water purifying unit 100 to the discharging port of the electrolytic cell 200, enables the purified water discharged from the water purifying unit 100 to be introduced to an inside the water storage tank 400. A portion of the purified water introduced to an inside the water storage tank 400 is used to clean the cork 500, and the remaining portion of the purified water introduced to an inside the water storage tank 400 is used to clean the water storage tank 400 and the pipes 30a and 30b that connect the water storage tank 400 to the discharging port of the electrolytic cell 200.

When the cleaning of the cork 500, the water storage tank 400 and the pipes is completed, the control unit 470 controls the opening/closing of the three-way valve 32 installed on the pipes 30a and 30b that connect the water storage tank 400 to the discharging port of the electrolytic cell 200, so that waste water, that is, the sterilization water having been used for the sterilization may be discharged to an outside.

The cleaning process using the purified water may be performed by a predetermined number of operation times. As an example, in a case when the number of cleaning operations is set to be two times, the control unit 470, in order for the cleaning process using the purified water to be performed one more time, may control the components.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. An apparatus for producing electrolytic reduced water, the apparatus comprising:
an electrolytic cell configured to produce electrolytic reduced water by electrolyzing purified water that is penetrated through a reverse osmosis filter of a water purifying unit;
a water storage tank configured to store the electrolytic reduced water;
a sterilization electrolytic cell configured to produce sterilization water by electrolyzing reverse osmosis waste water that is discharged from the water purifying unit; and
a control unit configured to perform a control operation to sterilize at least one of the water storage tank, a cork connected to the water storage tank, and a pipe that connect the water storage tank to the electrolytic cell by use of the sterilization water.

2. The apparatus of claim 1, wherein:
the sterilization water includes hypochlorous acid.

3. The apparatus of claim 1, wherein:
the reverse osmosis waste water is ion-concentrated liquid that fails to penetrate through the reverse osmosis filter.

4. The apparatus of claim 1, wherein:
the control unit, in a case of sterilizing according to an automatic sterilization mode, sterilizes the water storage tank and the pipe by using the sterilization water.

5. The apparatus of claim 4, wherein:
the control unit, after discharging the sterilization water that has been used in sterilizing the water storage tank and the pipe, performs a cleaning of the sterilized water storage tank and the sterilized pipe by using the purified water that is penetrated through the reverse osmosis filter.

6. The apparatus of claim 1, wherein:
the control unit, in a case of sterilizing according to a manual sterilization mode, sterilizes the cork, the water storage tank, and the pipe by using the sterilization water.

7. The apparatus of claim 6, further comprising:
a display unit configured to display information instructing to connect the cork to the sterilization electrolytic cell by using a hose.

8. The apparatus of claim 7, wherein:
the sterilization water, while being supplied from the sterilization electrolytic cell to the cork through the hose, sterilizes the cork.

9. The apparatus of claim 6, wherein:
the control unit, after discharging the sterilization water that has been used in sterilizing the cork, the water storage tank, and the pipe to an outside the water storage tank, performs a cleaning of the sterilized cork, the sterilized water storage tank, and the sterilized pipe by using the purified water that is penetrated through the reverse osmosis filter.

10. A method of controlling an apparatus for producing electrolytic reduced water, the method comprising:
at an electrolytic cell, producing electrolytic reduced water by electrolyzing purified water that is penetrated through a reverse osmosis filter of a water purifying unit;
at a water storage tank, storing the electrolytic reduced water;
at a sterilization electrolytic cell, producing sterilization water by electrolyzing reverse osmosis waste water that is discharged from the water purifying unit; and
at a control unit, performing a control operation such that the sterilization water sterilizes at least one of the water storage tank, a cork connected to the water storage tank, and a pipe that connect the water storage tank to the electrolytic cell by use of the sterilization water.

11. The method of claim 10, wherein:
the sterilization water includes hypochlorous acid.

12. The method of claim 10, wherein:
the reverse osmosis waste water is ion-concentrated liquid that fails to penetrate through the reverse osmosis filter.

13. The method of claim 10, wherein:
the performing of the control operation comprises, in a case of sterilizing according to an automatic sterilization mode, sterilizing the water storage tank and the pipe by using the sterilization water.

14. The method of claim 13, further comprising:
discharging the sterilization water having been used in sterilizing the water storage tank and the pipe to an outside the water storage tank; and
cleaning the sterilized water storage tank and the sterilized pipes, by using the purified water that is penetrated through the reverse osmosis filter.

15. The method of claim 10, wherein:
the performing of the control operation comprises, in a case of sterilizing according to a manual sterilization mode, sterilizing the cork, the water storage tank, and the pipe by using the sterilization water.

16. The method of claim 15, further comprising:
displaying information instructing to connect the cork to the sterilization electrolytic cell by using a hose.

17. The method of claim 16, wherein:
the sterilization water, while being supplied from the sterilization electrolytic cell to the cork through the hose, sterilizes the cork.

18. The method of claim 15, further comprising:
discharging the sterilization water having been used in sterilizing the cork, the water storage tank, and the pipe to an outside the water storage tank; and
cleaning the sterilized cork, the sterilized water storage tank, and the sterilized pipe, by using the purified water that is penetrated through the reverse osmosis filter.

19. A self cleaning apparatus for producing electrolytic reduced water, comprising:
a purifying unit to receive raw water that comprises a plurality of filters, wherein at least one filter is a reverse osmosis filter, to produce purified water and reverse osmosis waste water;
a electrolytic cell to receive the purified water to produce reduced water;
a sterilization electrolytic cell to receive the reverse osmosis waste water to produce sterilization water;
a water storage tank that is capable of receiving the purified water from the purifying unit, the reduced water from the electrolytic cell and the sterilization water from the sterilizing electrolytic cell;
a plurality of pipes to connect the different components;
a plurality of valves to control the flow the different types of waters between the components;
a control unit that automatically sterilizes at least one of the water storage tank, and a pipe that connect the water storage tank to the electrolytic cell by use of the sterilization water and that automatically cleans at least one of the water storage tank, and a pipe that connect the water storage tank to the electrolytic cell by use of the purified water.

20. A self cleaning apparatus for producing electrolytic reduced water of claim 19, wherein the reverse osmosis waste water is produced by having the removing the water from the purifying unit prior to be filtered by the reverse osmosis filter.
